(19) United States
(12) Patent Application Publication
(10) Pub. No.: US 2006/0143486 A1
(43) Pub. Date: Jun. 29, 2006

(54) System and method to profile an unconstrained power of a processor

(76) Inventors: Oren Lamdan, Kiryat Tivon (IL); Efraim Rotem, Haifa (IL); Lev Finkelstein, Netanya (IL)

Correspondence Address: John P. Ward;BLAKELY, SOKOLOFF, TAYLOR & ZAFMAN LLP, Seventh Floor, 12400 Wilshire Boulevard, Los Angeles, CA, 90025, US

(21) Appl. No.: 11/025,171

(22) Filed: Dec. 28, 2004

(51) Int. Cl. G06F 1/32; G06F 1/26

(52) U.S. Cl. 713/320

(57) ABSTRACT

A method and system to profile unconstrained power of a CPU are provided. The method includes identifying a rate of power constraining in the CPU, identifying a threshold to activate power constraining, and determining unconstrained power of the CPU based on the rate of power constraining and the threshold.

### BACKGROUND

1. Technical Field

One or more embodiments of the present invention generally relate to power management. In particular, certain embodiments relate to profiling unconstrained power of a processor.

2. Description of Related Art

As the trend toward advanced central processing units (CPUs) with more transistors and higher frequencies continues to grow, computer designers and manufacturers are often faced with corresponding increases in power and energy consumption. Increased power consumption can lead to overheating, which may negatively affect performance, and can significantly reduce battery life.

Modern CPUs have internal power control mechanisms that are responsible for constraining the CPU power usage and for preventing thermal overrun. Internal power control mechanisms usually consist of one or more on-die temperature sensors that are used as “thermal overrun indicators” and a power reduction mechanism that causes a processor to alternately move between low and high voltage/frequency operating points. A technique where a power reduction mechanism causes a processor to switch to a low voltage/frequency operating point once in a while may be referred to as throttling. A typical activation method of the above control mechanism is to determine a threshold temperature and to activate the power reduction mechanism for short periods of time as many times as it takes to maintain the temperature below the threshold.

A significant constraining factor in the design of CPU-based systems is the CPU's average power usage, rather than maximal power usage, because overheating of a CPU is more likely to be caused by extended periods of high power usage rather than short bursts of high power usage followed by a low usage or idle operation. The reduction of the CPU's average power usage (e.g., optimizing the power usage) may be addressed at all system levels: from the application level through the operation system (OS) and down to the CPU design itself.

Power usage optimizations at software layers (e.g., OS, application, etc.) usually require both access to internal CPU activity indicators and an ability to accurately estimate power usage for an application in order to be able to make power-performance tradeoff decisions (either in real time or for subsequent runs of the same software). The power usage pattern of an application may also be referred to as the power profile of an application. For example, many computer applications cause the CPU to consume relatively high power at high performance for short periods of time, while requiring relatively low power operation the rest of the time (e.g., idle while waiting for user input). For such applications, it may be inefficient to constrain the CPU power based on the peak power usage by the application, as it may unnecessarily reduce performance of the application. On the other hand, some computer applications cause the CPU to consume relatively high power for extended periods of time. The latter type of computer application may require tightening the power constraining mechanism for the duration of the extended peak power usage and relaxing the constraints during the low power usage periods. Ability to accurately power profile an application may allow precise tailoring of the power constraining mechanism to the application's power needs.

### BRIEF DESCRIPTION OF THE DRAWINGS

The embodiments of the present invention are illustrated by way of example and not limited by the accompanying drawings, in which like references indicate similar elements and in which:

FIG. 1 is a diagrammatic representation of a system within which unconstrained power of a processor is estimated, according to an embodiment of the present invention;

FIG. 2 is a flowchart illustrating a method to estimate unconstrained power of a processor, according to an embodiment of the present invention;

FIG. 2A is a flowchart illustrating operations to determine the rate of power constraining, according to one exemplary embodiment of the present invention

FIG. 2B is a flowchart illustrating operations to estimate unconstrained power where the thermal constraints are artificially tightened, according to one exemplary embodiment of the present invention; and

FIG. 3 is a diagrammatic representation of a computer system, within which a set of instructions, for causing the machine to perform any one or more of the methodologies discussed herein, may be executed.

### DETAILED DESCRIPTION

Effective power/performance optimization at the software level may require accurate CPU power profiling capabilities. In order to allow runtime optimizations of software applications, power profiling data should be available in real time. In order to accurately power profile an arbitrary application, it may be necessary to determine the unconstrained power usage (or simply unconstrained power) of that application. Unconstrained power is a measure of usage of power in a system, provided there are no power constraining mechanisms. Unconstrained power with respect to an application utilizing a CPU (application's unconstrained power) may also be referred to as CPU's unconstrained power. There are currently available techniques to perform measurements of CPU's unconstrained power. The existing techniques, however, may require additional hardware and often may be used only in laboratory conditions

The use of temperature sensors as “thermal overrun indicators” is an efficient way for avoiding power (thermal) overrun. Temperature sensors, however, do not necessarily provide a way to accurately monitor the CPU's unconstrained power. One reason is that a temperature reading only provides a momentary thermal status. Furthermore, when a CPU activates its power constraining mechanisms in order to prevent thermal overrun, it also changes the actual power dissipation and temperature. Therefore, the temperature reading is not always an accurate indicator of the CPU's unconstrained power.

A more reliable approach to estimate CPU's unconstrained power may include determining a rate with which the CPU's power constraining mechanism is activated for a particular thermal threshold and identifying unconstrained power that corresponds to the determined rate. This approach may be implemented, in one embodiment, utilizing existing power-constraining components of a CPU. For example, the amount of throttling that is required in order to maintain the temperature of a CPU below a particular threshold can be accurately translated into the real-time unconstrained CPU power. In one embodiment, a real time estimator of unconstrained power may monitor the unconstrained power of a CPU by obtaining the thermal threshold (e.g., by obtaining the temperature reading from the CPU's temperature sensor), measuring the amount of throttling within a given timeframe, and consulting a lookup table containing correlation information.

The idea behind the real time estimator of unconstrained power is based on the following observation: monitoring the activation of the CPU's power constraining mechanism over a certain timeframe, while knowing the constraining mechanism's temperature target, may be accurately translated into the unconstrained power of the CPU. By way of analogy, this idea may be thought of as a mechanism to monitor the energy consumed by a car by monitoring the speed of the car and the extent to which the car brakes were used. The more frequently the brakes are used in order to maintain a particular speed, the greater is the unconstrained energy of the car.

A method utilizing temperature reading and the rate of power constraining (e.g., throttling) within a given timeframe may provide an accurate real-time measure for the CPU's unconstrained power, while exploiting the existing on-die components. Thus, the unconstrained power may be estimated and an arbitrary application may be power profiled without significant modifications to existing hardware and software and, in one embodiment, with no need for sophisticated and expensive measurement equipment.

The method and system to estimate a CPU's unconstrained power may be utilized, for example, to power profile applications in real-time in order to optimize power-performance at runtime, to power profile applications offline for offline compiling-based power-performance optimizations, for laboratory studies that require power profiling, as well as for other purposes. It will be noted that, in on embodiment, the method and system described below may be utilized for any kind of a processor that possesses a throttle meter.

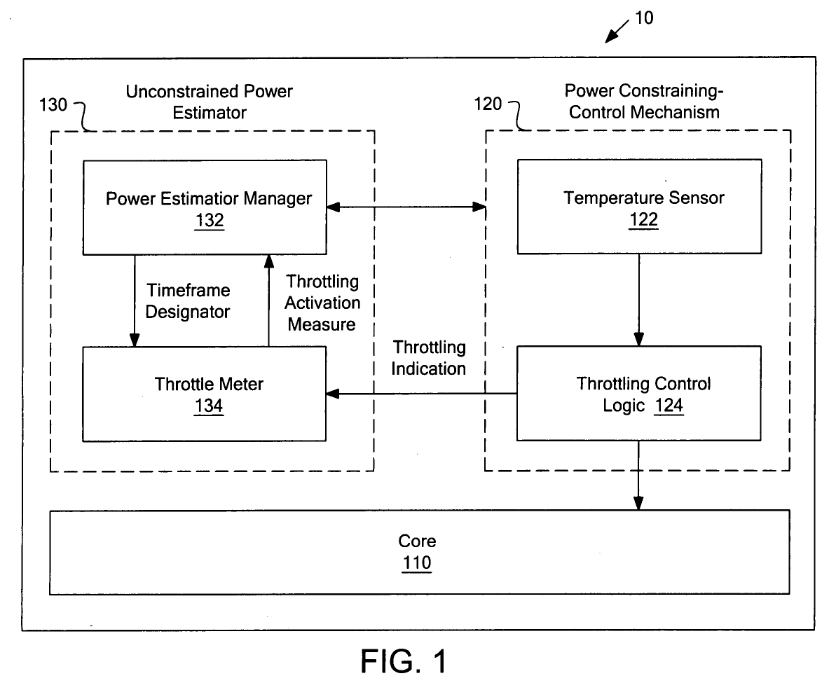

FIG. 1 is a diagrammatic representation of a system 10 implementing a method to estimate unconstrained power of a processor, according to an embodiment of the present invention. The system 10 includes a processor core 110, a power constraining control mechanism 120, and an unconstrained power estimator 130. The processor core 110 consists, in one embodiment, of a series of logic gates producing specific outputs for a given set of inputs and may be designed for general-purpose functions. The power constraining control mechanism 120 operates on the processor core 110 and includes a temperature sensor 122 and a throttling logic 124. The power constraining control mechanism 120 is responsible for maintaining the temperature of the processor core 110 below a particular threshold in order to avoid thermal overrun. In one embodiment, the temperature sensor 122 or an additional sensor may be attached to the processor heat sink so that the temperature readings of the temperature sensor 122 are independent of the ambient temperature and the influence of other components of the system. The unconstrained power estimator 130 may include a power estimator manager 132, which, in one embodiment, may be implemented as a software component, and a throttle meter 134, which, in one embodiment, may be implemented as a hardware component.

In operation, according to one embodiment of the present invention, the power estimator manager 132 determines the time frame (e.g., a predetermined period of time) for monitoring activation of the power constraining control mechanism 120 (e.g., throttling) and communicates the time frame to the throttle meter 134. The throttle meter 134 communicates with the throttling control logic to determine the rate at which the power constraining mechanism 120 is activated (e.g., by counting throttling events). The power estimator manager 132 reads the result produced by the throttle meter 134 (e.g., the rate of activation of the power constraining mechanism 120 or throttling rate) at the end of the time frame and translates it into unconstrained power values. The translation of the result produced by the throttle meter 134 into unconstrained power values may be accomplished using a pre-computed lookup table. Such lookup table may include correlation data between unconstrained power of a processor and a throttling rate for a particular thermal threshold. In one embodiment, the throttle meter 134 counts throttling events over the timeframe designated by the power estimator manager 132 and returns the number of throttling events to the power estimator manager 132. Thus, the unconstrained power of a processor is estimated in real time, which may allow for power-performance tradeoff decisions to be made based on the resulting power profile of the application utilizing the processor.

It will be noted that the translation of the result produced by the throttle meter 134 into unconstrained power values may be performed offline, and the resulting power profile of the application may be utilized for optimizing power usage of the applications during subsequent runs of the application.

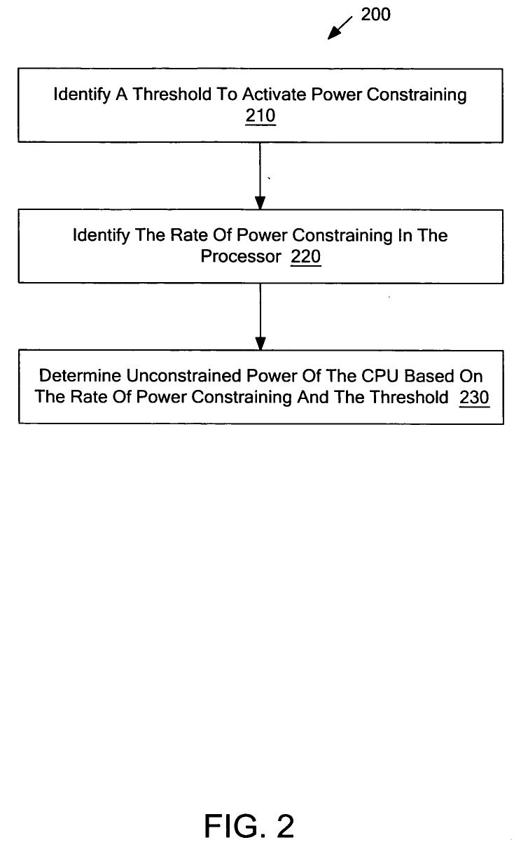

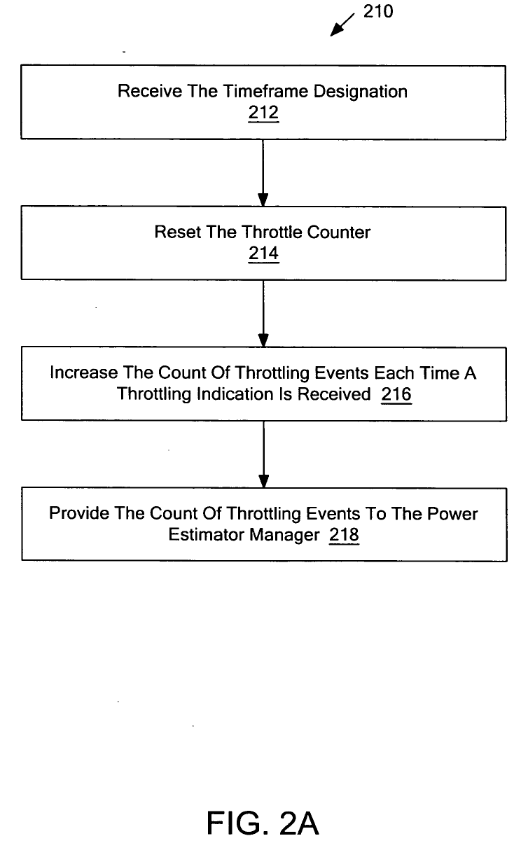

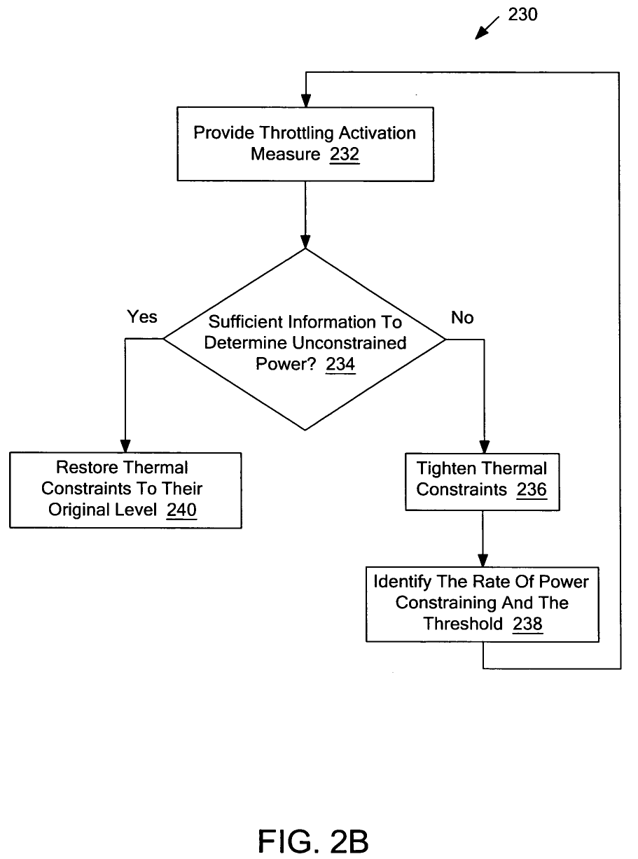

FIG. 2 is a flowchart illustrating a method 200 to estimate unconstrained power of a processor, according to an embodiment of the present invention. At operation 210, the unconstrained power estimator 130 identifies the threshold (e.g., a thermal threshold or the temperature reading at the temperature sensor 122). At operation 220, the unconstrained power estimator 130 identifies a rate of power constraining in the system 10. Based on the rate of power constraining and the threshold, the unconstrained power estimator 130 determines unconstrained power of the processor at operation 230. It will be noted, that the identifying of the threshold (operation 210) may be performed subsequent to or simultaneously with the identifying the rate of power constraining in the system 10 (operation 220). The operations performed by the unconstrained power estimator 130 to determine the rate of power constraining are illustrated in FIG. 2A.

Referring to FIG. 2A, at operation 212, the throttle meter 134 receives the timeframe designation from the power estimator manager 132 in order to commence operations to determine the rate of power constraining (e.g., a throttling activation measure) and resets its throttle counter at operation 214. At operation 216, the throttle meter 134 monitors occurrences of throttling events triggered by the throttling control logic 124. Each time the throttle meter 134 receives a throttling indication from the throttling control logic 124 during the designated timeframe, it increases the count of throttling events. The count of throttling events over the designated timeframe is provided, at operation 218, to the power estimator manager 132 to allow the power estimator manager 132 to determine the rate of power constraining. It will be noted, that the rate of power constraining may be determined, in one embodiment, by determining, for example, time intervals between the throttling events, rather than counting the throttling events occurrences.

The method illustrated in FIGS. 2 and 2A may be utilized without modifying thermal constraints of the system 10 if the application that is the subject of power profiling is thermally limited, i.e., the thermal constraints cause a certain number of throttling events to occur. In order to profile an arbitrary application, the unconstrained power estimator 130 may cause the power constraining control mechanism to artificially tighten the thermal constraints if the throttle meter 134 determines that no throttling occurs during the designated timeframe or the number of throttling events does not provide statistically significant information. The thermal constraints may be artificially tightened, for example, by decreasing the thermal threshold used for throttling, or by turning off the fan. The operations performed by the unconstrained power estimator 130 to determine unconstrained power in the event where the thermal constraints of the system 10 may be artificially tightened are illustrated in FIG. 2B.

Referring to FIG. 2B, the power estimator manager 132 receives, at operation 322, information from the throttle meter 134. If the power estimator manager 132 determines, at operation 234, that it is unable to determine unconstrained power of the processor based on the information provided by the throttle meter 134 (e.g., the throttling events counter reported zero throttling events or the number of throttling events is statistically insignificant), the thermal constraints of the system 10 are tightened at operation 236 (e.g., by the power estimator manager 132) and the rate of power constraining and the threshold are identified at operation 238 (the operations 210 through 230 of FIG. 2 are repeated). If, again, no meaningful results are returned by the throttle meter 134, the thermal constraints may be tightened further until a satisfactory result is obtained. Alternatively, a default unconstrained power estimate may be used instead. The thermal constraints are restored to their original level at operation 240 when the unconstrained power estimator is able to determine unconstrained power with acceptable precision.

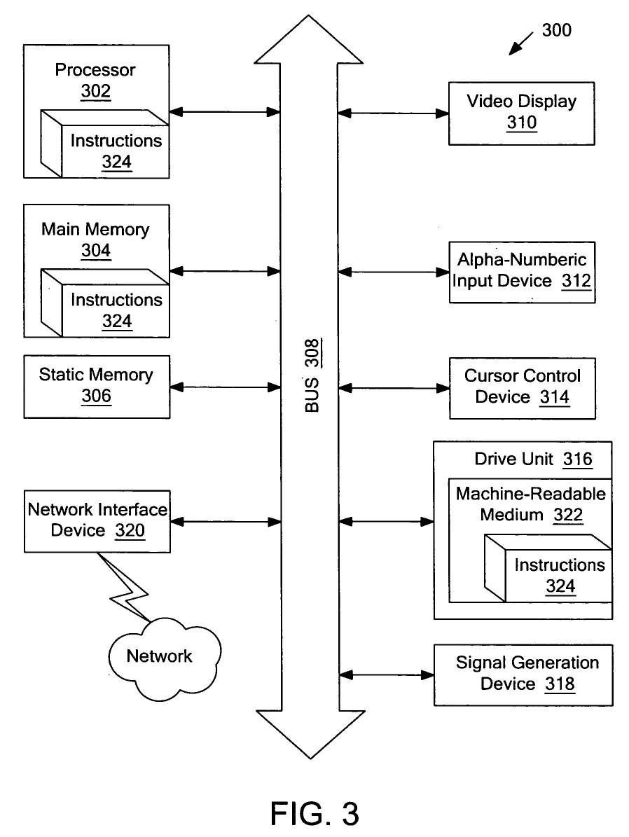

FIG. 3 shows a diagrammatic representation of machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to profile unconstrained power of a processor have been described. Although the method and the system have been described with reference to specific exemplary embodiments, it will be evident that various modifications and changes may be made to these embodiments without departing from the broader spirit and scope of the disclosure. Accordingly, the specification and drawings are to be regarded in an illustrative rather than a restrictive sense.

1. A machine-readable medium having stored thereon data representing sets of instructions which, when executed by a machine, cause the machine to:
identify a rate of power constraining in a processor;
identify a threshold to activate power constraining; and
determine unconstrained power of the processor based on the rate of power constraining and the threshold.

2. The medium of claim 1, wherein the identifying of the rate of power constraining includes monitoring power constraining for a period of time.

3. The medium of claim 1, wherein the unconstrained power of the processor is determined utilizing a lookup table, the lookup table providing correlation between rates of activation and unconstrained powers.

4. The medium of claim 1, wherein the power constraining is a throttling event.

5. The medium of claim 1, further having stored thereon data representing sets of instructions which, when executed by a machine, cause the machine to:
responsive to identifying the rate of power constraining as below a predetermined activation rate, modify the threshold to generate a new threshold;
monitor power constraining in the processor to determine a new rate of power constraining; and
determine a new unconstrained power of the processor utilizing the rate of power constraining and the new threshold.

6. The medium of claim 1, wherein the determining of the unconstrained power of the processor is performed in real time.

7. The medium of claim 1, wherein the determining of the unconstrained power of the processor is performed offline.

8. An apparatus comprising:
a power constraining component to utilize a threshold to activate power constraining;
a throttle meter to determine a rate of power constraining in the processor; and
a power estimator manager to determine unconstrained power of the processor based on the rate of power constraining and the threshold.

9. The apparatus of claim 8, wherein the power estimator manager to designate a period of time for determining the rate of power constraining in the processor.

10. The apparatus of claim 8, wherein the power estimator manager to utilize a lookup table storing correlation between frequencies of power constraining and unconstrained powers.

11. The apparatus of claim 8, wherein the activation of power constraining is a throttling event.

12. The apparatus of claim 8, wherein the power estimator manager to:
modify the threshold to generate a new threshold responsive to identifying the rate of power constraining as below a minimal rate of power constraining;
receive from the throttling meter a new rate of power constraining based on the new threshold; and
determine a new unconstrained power of the processor utilizing the new rate of power constraining and the new threshold.

13. The apparatus of claim 8, wherein the power estimator manager to determine unconstrained power of the processor in real time.

14. A system comprising:
a controller to activate power constraining in a processor residing in a mobile device based on a threshold; and
a power estimator coupled to the controller to determine unconstrained power of the processor based on rate of power constraining and the threshold.

15. The system of claim 14, wherein the power estimator includes:
a throttle meter to determine a rate of power constraining in the processor during a period of time; and
a power estimator manager to designate the period of time to the throttle meter, to receive the rate of power constraining from the throttle meter and to identify an entry in a lookup table associated with the rate of power constraining and the threshold.

16. The system of claim 14, wherein the rate of power constraining is a rate of throttling events.

17. The system of claim 14, wherein the power estimator to:
modify the threshold to generate a new threshold responsive to identifying the rate of power constraining as below a minimal rate of power constraining;
determine a new rate of power constraining based on the new threshold; and
determine a new unconstrained power of the processor utilizing the new rate of power constraining and the new threshold.

18. The system of claim 14, wherein the power estimator to determine unconstrained power of the processor in real time.

19. A method including:
identifying a rate of power constraining in a processor;
identifying a threshold to activate power constraining; and
determining unconstrained power of the processor based on the rate of power constraining and the threshold.

20. The method of claim 19, wherein the identifying of the rate of power constraining includes monitoring power constraining for a period of time.

21. The method of claim 19, wherein the unconstrained power of the processor is determined utilizing a lookup table, the lookup table providing correlation between rates of activation and unconstrained powers.

22. The method of claim 19, wherein the power constraining is a throttling event.

23. The method of claim 19, further including:
responsive to identifying the rate of power constraining as below a predetermined activation rate, modifying the threshold to generate a new threshold;
monitoring power constraining in the processor to determine a new rate of power constraining; and
determining a new unconstrained power of the processor utilizing the rate of power constraining and the new threshold.

24. The method of claim 19, wherein the determining of the unconstrained power of the processor is performed in real time.

25. The method of claim 19, wherein the determining of the unconstrained power of the processor is performed offline.
